(19) United States
(12) Patent Application Publication
(10) Pub. No.: US 2017/0149821 A1
(43) Pub. Date: May 25, 2017

(54) Method And System For Protection From DDoS Attack For CDN Server Group

(71) Applicants: Le Holdings (Beijing) Co., Ltd., Beijing (CN); LeCloud Computing Co., Ltd., Beijing (CN)

(72) Inventor: Hongfu Li, Beijing (CN)

(21) Appl. No.: 15/252,953

(22) Filed: Aug. 31, 2016

Related U.S. Application Data
(63) Continuation of application No. PCT/CN2016/083250, filed on May 25, 2016.

(30) Foreign Application Priority Data
Nov. 25, 2015 (CN) 201510828940.4

(51) Int. Cl. H04L 29/06

(52) U.S. Cl. CPC H04L 63/1458; H04L 63/101; H04L 67/10

(57) ABSTRACT

A method and system for protection from DDoS attack for a CDN server group. The CDN server group includes a plurality of CDN servers and a center server. The method includes: sending by each CDN server access source information of an access request to the center server; counting by the center server the number of access requests in each CDN server; determining by the center server access requests, of which the number is greater than a predetermined threshold, corresponding to the same access source information in each CDN server as DDoS attacks, and generating by the center server a blacklist; issuing by the center server the blacklist to the plurality of CDN servers; and making the CDN servers refuse to provide a service to an access source in the blacklist. Accordingly, the CDN server group is protected against DDoS attacks from the entire network.

### CROSS REFERENCE TO RELATED APPLICATIONS

This application is a continuation of International Application No. PCT/CN2016/083250, filed on May 25, 2016, which is based upon and claims priority to Chinese Patent Application No. 201510828940.4, filed on Nov. 25, 2015, the entire contents of which are incorporated herein by reference.

### TECHNICAL FIELD

The disclosure relates to the technical field of network security, and more particularly to a method and system for protection from DDoS attack for a CDN server group.

### BACKGROUND

With the development of the Internet, users pay more attention to browsing speed and effects of websites when using the network. However, due to rapid increase of Internet users and a much long network access path, the user access quality has been severely affected. Especially, when congestion caused by the burst of heavy data traffic appears on a link between a user and a website, the user access quality is poor. Therefore, poor access quality is a pressing issue for regions with a sharply rising number of remote Internet users.

The CDN (Content Delivery Network) is an intelligent virtual network based on the existing Internet and formed by placing CDN servers throughout the network. The CDN can re-direct a user request to the nearest service node in real time according to comprehensive information including such as the connection between network traffic and each node, a load condition, a distance from each node to a user and a response time to the request, so that a node relatively close to the user can be selected to send required content to the user, thereby relieving network congestion and improving the website response speed.

However, with the development and popularization of Internet technologies, servers or systems on the network are facing more and more complex network attacks. The DDoS (Distributed Denial of Service) attack is a serious network attack. It utilizes a large number of puppet machines to simultaneously attack a server or system. As a result, the attacked system cannot support normal service access due to bandwidth congestion, server resource exhaustion or the like. What's worse, by use of legitimate data request technologies and puppet machines, DDoS attacks become a formidable network attack.

In the prior art, host settings and network settings are used to prevent DDoS attacks.

On one hand, host setting used to prevent the DDoS attacks in the prior art is implemented by setting all servers on all host platforms to defend against DDoS attacks. For example, unnecessary services are turned off, the number of simultaneously open Syn semi-connection is restricted, the time-out time of the Syn semi-connection is shortened, and system patches are updated in time.

On the other hand, network setting used to prevent the DDoS attacks in the prior art includes setting of two external interface devices, namely, a firewall and a router. For example, the firewall setting includes the followings: non-open service access to hosts is forbidden, the greatest number of simultaneously open Syn connection is restricted, access to specific IP addresses is restricted, an anti-DDoS attribute of the firewall is enabled, and outgoing access to servers opening to the outside world is strictly restricted. The router setting includes the followings: an SYN date packet traffic rate is set, an ISO with a lower version is updated, and log server is established for the router.

However, the above technical schemes for preventing the DDoS attacks have the following problems.

On one hand, the use of the black hole technology as well as router filtering and speed limitation not only consumes lots of server resources, but also blocks part of effective services, so that the processing efficiency of a server to user access requests is reduced and user experience is seriously affected. On the other hand, although an adequate response capacity for providing DDoS attack protection can be ensured by deploying a lot of redundant devices, the DDoS attack protection cost is too high.

Furthermore, with the development and popularization of Internet technologies, criminals may use a larger number of puppet machines to launch DDoS attacks to all CDN servers on a CDN platform so as to attack a center server in the CDN platform. According to the technical scheme in the prior art, when a DDoS attacks a CDN server, the server adopts a series of anti-DDoS attack technologies to identify and defend against the DDoS attack. If a DDoS with the same attack source as that of the above DDoS attacks a plurality of CDN servers in the CDN platform, all of the CDN servers in the CDN platform need to identify the attack source of the DDoS before defending against the DDoS. However, the technical problems lie in that the processing efficiency of the CDN platform to the DDoS attacks is reduced, and the website response speed slows down. Therefore, how to simply and effectively protect the CDN platform from DDoS attack sources is a problem requiring urgent solutions in the field.

### SUMMARY

The present application aims to solve the at least one of the above technical problems, and provide a method and system for protection from DDoS attack for a CDN server group to effectively protect against large-scale DDoS attacks.

According to an aspect of an embodiment of the present application, there is provided a method for protection from DDoS attack for a CDN server group including a plurality of CDN servers and a center server, the method including:

sending by each CDN server access source information of an access request to the center server;

counting by the center server the number of access requests corresponding to the same access source information in each CDN server within a period;

determining by the center server access requests, of which the number is greater than a predetermined threshold, corresponding to the same access source information in each CDN server as DDoS attacks, and generating by the center server a blacklist based on the access source information of the above access requests;

issuing by the center server the blacklist to the plurality of CDN servers in the CDN server group; and

making the CDN servers refuse to provide a service to an access source in the blacklist.

According to another aspect of an embodiment of the present application, there is provided a system for protection from DDoS attack for a CDN server group including a plurality of CDN servers and a center server, wherein

each CDN server having at least one processor, a memory in electronic communication with the processor and instructions stored in the memory, includes:

a collecting unit implemented by the at least one processor and configured to collect access source information of an access request,

a sending unit implemented by the at least one processor and configured to send the access source information to the center server,

a blacklist receiving unit, and

a service controlling unit implemented by the at least one processor and configured to be associated with the blacklist receiving unit, so as to refuse service provision to an access source in a blacklist; and

the center server having at least one processor, a memory in electronic communication with the processor and instructions stored in the memory, includes:

a counting unit implemented by the at least one processor and configured to count the number of access requests corresponding to the same access source information in each CDN server within a period,

a blacklist generating unit implemented by the at least one processor and configured to determine access requests, of which the number is greater than a predetermined threshold, corresponding to the same access source information in each CDN server as DDoS attacks, and generate a blacklist based on the access source information of the above access requests, and

an issuing unit implemented by the at least one processor and configured to issue the blacklist to the blacklist receiving units in the plurality of CDN servers in the CDN server group.

### BRIEF DESCRIPTION OF THE DRAWINGS

In order to more clearly illustrate the embodiments of the present application, figures to be used in the embodiments will be briefly introduced in the following. Apparently, figures in the following description are some embodiments of the present application, and other figures can be obtained by those skilled in the art based on these figures without inventive efforts.

FIG. 1 shows a flow chart of a method for protection from DDoS attack for a CDN server group according to an embodiment of the present application;

FIG. 2 shows a schematic structural drawing of a system for protection from DDoS attack for a CDN server group according to an embodiment of the present application;

FIG. 3 shows a schematic structural drawing of a CDN platform on which a plurality of CDN server groups shown in FIG. 2 are arranged according to an embodiment of the present application; and

FIG. 4 is a schematic structural drawing of a computer system of a terminal device or server for realizing the embodiments of the present application.

### DETAILED DESCRIPTION

In order to make the purpose, technical solutions, and advantages of the embodiments of the application more clearly, technical solutions of the embodiments of the present application will be described clearly and completely in conjunction with the figures. Obviously, the described embodiments are merely part of the embodiments of the present application, but not all embodiments. Based on the embodiments of the present application, other embodiments obtained by the ordinary skill in the art without inventive efforts are within the scope of the present application.

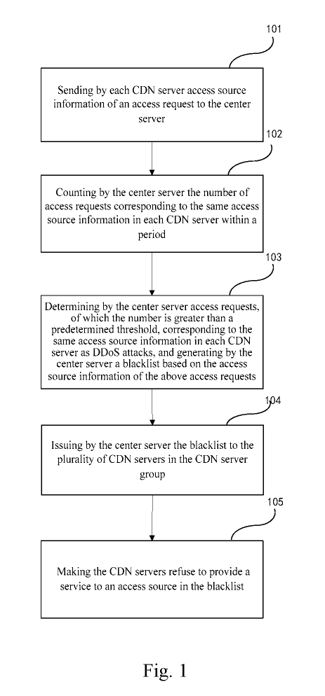

FIG. 1 shows a method for protection from DDoS attack for a CDN server group according to an embodiment of the present application. The CDN server group includes a plurality of CDN servers and a center server, and the method includes:

S101: sending by each CDN server access source information of an access request to the center server;

S102: counting by the center server the number of access requests corresponding to the same access source information in each CDN server within a period;

S103: determining by the center server access requests, of which the number is greater than a predetermined threshold, corresponding to the same access source information in each CDN server as DDoS attacks, and generating by the center server a blacklist based on the access source information of the above access requests;

S104: issuing by the center server the blacklist to the plurality of CDN servers in the CDN server group; and

S105: making the CDN servers refuse to provide a service to an access source in the blacklist.

The method provided by the embodiment of the present application has the following advantages.

Attack sources of DDoS attacks are marked in a blacklist, and access of all marked DDoS attack sources are rejected, so that effective protection against the DDoS attacks is realized. The center server completes identification of access of the DDoS attack sources to all CDN servers, so that resource consumption of each CDN server is reduced. Meanwhile, the access of the DDoS attack sources to the center server is avoided as all CDN servers send access source information to the center server, thereby effectively hiding and protecting the center server. After identifying an attack source of a DDoS which attacked one CDN server in a CDN server group, the center server records the DDoS attack source into a blacklist, and issues the blacklist to all CDN servers in the CDN server group, so that blacklists in all CDN servers in the CDN server group are updated synchronously, and the CDN server group is protected against DDoS attacks from the entire network. When a blacklisted DDoS attack source attempts to attack each CDN server in the CDN server group, the center server does not need to identify the DDoS attack source again, thereby reducing the resource consumption of the center server in terms of DDoS attack protection.

In the method provided by an embodiment of the present application, the access source information includes IP information, URL information and/or Refer information of access request sources. The method specifically includes: sending by each CDN server access source information of an access request to a center server; and counting by the center server the number of access requests corresponding to the same access source information in each CDN server within a period. For example, the number of access of one IP of one CDN server to said one CDN server within a period is counted; the total number of access of one URL of one CDN server to said one CDN server within a period is counted; the total number of access of one Refer of one CDN server to said one CDN server within a period is counted; and numbers of access requests of the same IP, URL and/or Refer in each CDN server are acquired by repeating the above processing.

The method further includes: determining by the center server access requests, of which the number is greater than a predetermined threshold, corresponding to the same access source information in each CDN server as DDoS attacks, and generating by the center server a blacklist based on the access source information of the above access requests. For example, the center server compares the numbers of access requests of the same IP, URL and/or Refer in each CDN server with the predetermined threshold, and determines access requests, of which the number is greater than the predetermined threshold, corresponding to the same IP, URL and/or Refer as DDoS attacks. Specifically, determining by the center server access requests, of which the number is greater than the predetermined threshold, corresponding to the same access source information in each CDN server as the DDoS attacks, and generating by the center server the blacklist based on the access source information of the above access requests includes the following sub-steps: I) presetting an IP normal threshold, comparing the number of access requests of the same IP with the IP normal threshold, and determining the access requests of the same IP as DDoS attacks when the number of the access requests of the same IP is greater than the IP normal threshold; II) presetting a URL normal threshold, comparing the number of access requests of the same URL with the URL normal threshold, and determining the access requests of the same URL as DDoS attacks when the number of the access requests of the same URL is greater than the URL normal threshold; III) presetting a Refer normal threshold, comparing the number of access requests of the same Refer with the Refer normal threshold, and determining the access requests of the same Refer as DDoS attacks when the number of the access requests of the same Refer is greater than the URL normal threshold; and IV) generating the blacklist according to the access requests, determined as DDoS attacks, of the IP, URL and/or Refer. The DDoS attack identifications in the sub-steps I), II) and III) are independent from one another, while the sub-steps I), II) and III) may be executed synchronously or progressively. The thresholds set in the above sub-steps may be reference values determined based on experience or several experiments.

The method further includes issuing by the center server the blacklist to the plurality of CDN servers in the CDN server group. For example, the center server issues the blacklist generated based on the access requests of one CDN server to other CDN servers in the CDN server group. Preferably, the center server issues the blacklist generated based on the requests of access to one CDN server to each CDN server in the CDN server group.

The method further includes making the CDN servers refuse to provide a service to an access source in the blacklist. For example, the CDN servers in the CDN server group refuse to provide a service to the IP, URL and/or Refer in the blacklist. Preferably, the CDN servers in the CDN server group refuse to provide a service to each of the IP, URL and/or Refer in the blacklist.

As an improvement of the method provided by the present embodiment, the CDN server group may be a plurality of CDN server groups arranged on a CDN platform and classified based on different network types.

Thus, the CDN platform is divided into a plurality of CDN server groups based on network types. For instance, the CDN platform includes a first network type “China Telecom”, a second network type “China Unicom”, and other telecommunication network types. So, the CDN platform is divided into a plurality of CDN server groups based on the first network type “China Telecom”, the second network type “China Unicom”, and other telecommunication network types.

In general, a DDoS attack source will attack servers in a particular network type. As the CDN platform is divided into a plurality of CDN server groups based on the network types, when CDN servers in one of CDN server groups in the CDN platform are attacked, servers in other CDN server groups can be punctually called to replace the attacked CDN servers. Thus, the CDN platform can schedule CDN servers based on monitoring of DDoS attacks to ensure normal operation of a website.

As a further optimization of the method provided by the present embodiment, after a center server in any one of the plurality of CDN server groups issues the blacklist to a plurality of CDN servers in said one server group, the center server selectively shares the blacklist with center servers in other CDN server groups.

By sending the blacklist of one of CDN server groups in the CDN platform to other CDN server groups in the CDN platform, blacklists in all CDN server groups in the CDN platform are updated synchronously, and the CDN platform is protected against DDoS attacks from the entire network. Further, when a blacklisted DDoS attack source attempts to attack each CDN server in a CDN server group, the center server does not need to identify the DDoS attack source again, thereby reducing the resource consumption of the center server in terms of DDoS attack protection.

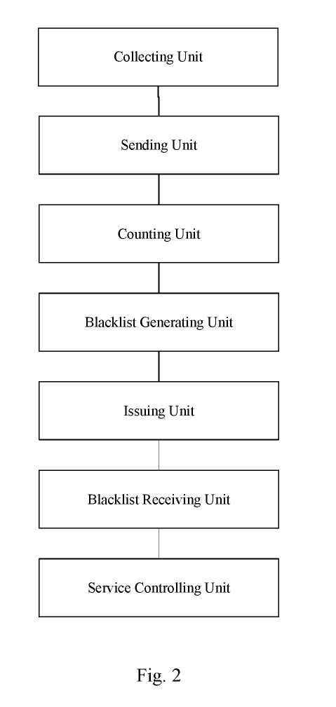

FIG. 2 shows a system for protection from DDoS attack for a CDN server group including a plurality of CDN serves and a center server, wherein

each CDN server includes:

a collecting unit configured to collect access source information of an access request,

a sending unit configured to send the access source information collected by the collecting unit to the center server,

a blacklist receiving unit, and

a service controlling unit configured to be associated with the blacklist receiving unit, so as to refuse service provision to an access source in a blacklist; and

the center server includes:

a counting unit configured to count the number of access requests corresponding to the same access source information in each CDN server within a period,

a blacklist generating unit configured to determine access requests, of which the number is greater than a predetermined threshold, counted by the counting unit and corresponding to the same access source information in each CDN server as DDoS attacks, and generate a blacklist based on the access source information of the above access requests, and

an issuing unit configured to issue the blacklist generated by the blacklist generating unit to the blacklist receiving units in the plurality of CDN servers in the CDN server group.

The DDoS attack protecting system for the CDN server group provided by the embodiments may be a server or server cluster, wherein each unit may be a separate server or server cluster. Thus, interactions among the above units are that among the servers or server clusters corresponding to respective units, and the plurality of servers or server clusters constitute the DDoS attack protecting system for the CDN server group provided by the present application.

In an alternative embodiment, several units in the above multiple units together form a server or server cluster. For example, the collecting unit, the sending unit, the blacklist receiving unit and the service controlling unit together constitute a first server or first server cluster, and the counting unit, the blacklist generating unit and the issuing unit form a second server or second server cluster.

Here, the interaction among the above units is that between the first and second servers or the first and second server clusters, and the first and second servers or the first and second server clusters constitute the DDoS attack protecting system for the CDN server group provided by the present application.

The system provided by the embodiments of the present application has the following advantages.

Attack sources of DDoS attacks are marked in a blacklist, and access of all marked DDoS attack sources are rejected, so that effective protection against the DDoS attacks is realized. The center server completes identification of access of the DDoS attack sources to all CDN servers, so that resource consumption of each CDN server is reduced. Meanwhile, the access of the DDoS attack sources to the center server is avoided as all CDN servers send access source information to the center server, thereby effectively hiding and protecting the center server. After identifying a DDoS attack source which attacks one CDN server in a CDN server group, the center server records the DDoS attack source into a blacklist, and issues the blacklist to all CDN servers in the CDN server group, so that blacklists in all CDN servers in the CDN server group are updated synchronously, and the CDN server group is protected against DDoS attacks from the entire network. When a DDoS attack source in a blacklist attempts to attack each CDN server in the CDN server group, the center server does not need to identify the DDoS attack source again, thereby reducing the resource consumption of the center server in terms of DDoS attack protection.

It should be noted that related units may be implemented by a hardware processor.

In the method provided by an embodiment of the present application, the access source information includes IP information, URL information and/or Refer information.

As an improvement of the embodiment shown in FIG. 2, the collecting unit may be an nginx module.

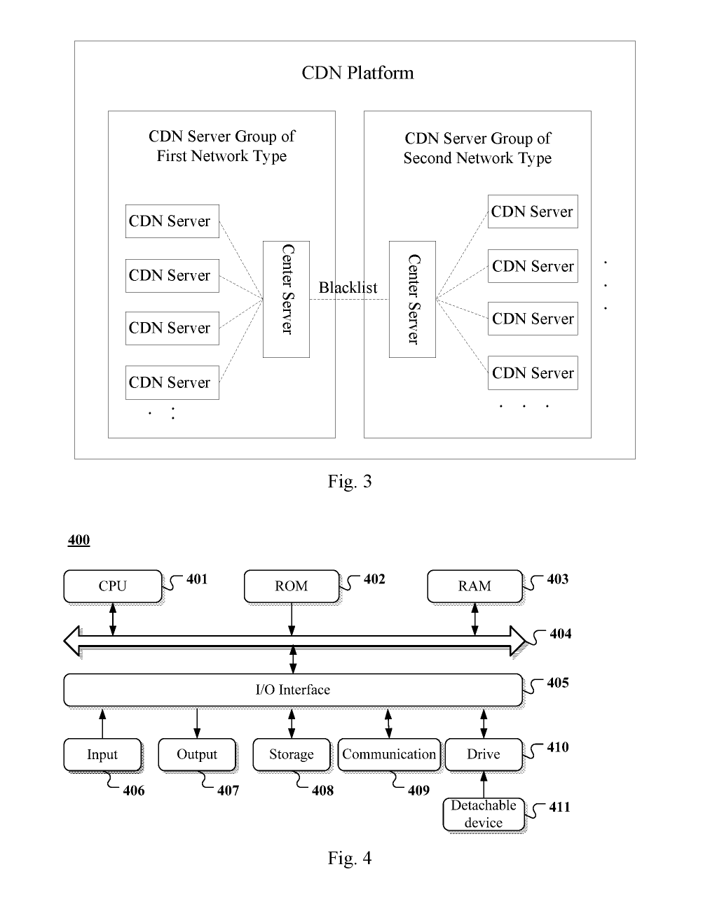

FIG. 3 shows a CDN platform on which a plurality of CDN server groups shown in FIG. 2 are arranged, and the plurality of CDN server groups are arranged on the CDN platform and classified based on different network types.

In general, a DDoS attack source will attack servers in a particular network type. As the CDN platform is divided into a plurality of CDN server groups based on the network types, when CDN servers in one of CDN server groups in the CDN platform are attacked, servers in other CDN server groups can be timely called to replace the attacked CDN servers. Thus, the CDN platform can schedule CDN servers based on monitoring of DDoS attacks to ensure normal operation of a website.

As an improvement of FIG. 3, a center server in any one of the plurality of CDN server groups is configured to selectively share a blacklist with center servers in other CDN server groups.

By sending the blacklist of one of CDN server groups in the CDN platform to other CDN server groups in the CDN platform, blacklists in all CDN server groups in the CDN platform are updated synchronously, and the CDN platform is protected against DDoS attacks from the entire network. Further, when a blacklisted DDoS attack source attempts to attack each CDN server in a CDN server group, the center server does not need to identify the DDoS attack source again, thereby reducing the resource consumption of the center server in terms of DDoS attack protection.

FIG. 4 is a schematic structural drawing of a computer system of a terminal device or server for realizing each CDN server or a center server according to the embodiments of the present application. The computer system includes a central processing unit (CPU) 401 which can perform various appropriate actions and processing according to a program stored in a read-only memory (ROM) 402 or a program loaded to a random access memory (RAM) 403 from a storage part 408. Various programs and data required during operation of the system are also stored in the RAM 403. The CPU 401, the ROM 402 and the RAM 403 are connected with one another via a bus 404. An Input/Output (I/O) interface 405 is also connected to the bus 404.

Components connected to the Input/Output (I/O) interface 405 includes an input part 406 including a keyboard, a mouse and the like, an output part 407 including a cathode ray tube (CRT), a liquid crystal display (LCD) and the like, the storage part 408 including a hard disk and the like, and a communication part 409 of network interface cards including an LAN card, a modem, etc. The communication part 409 performs communication processing via a network such as the Internet. A driver 410 is connected to the Input/Output (I/O) interface 405 as required. A removable medium 411 such as a magnetic disk, an optical disk, a magneto-optical disk or a semiconductor memory is installed on the driver 410 as required so as to enable a computer program to read out from the removable medium to be installed into the storage part 408 according to the needs.

Particularly, according to the embodiments of the present application, the steps described in the above reference flow charts may be implemented as a computer program. For example, the embodiments of the present application include a computer program product including a computer program which is tangibly contained in a machine-readable medium, and the computer program includes a program code for performing the method as shown in the flow chart. In such embodiments, the computer program may be downloaded and installed from the network via the communication part 409, and/or may be installed from the removable medium 411.

In one aspect of application of the present application, system for protection from DDoS attack protecting for the CDN server group, provided by the embodiments of the present application, may be embedded in the center server of the CDN server group and the CDN servers as a functional element.

It should be noted that, embodiments of the present application and the technical features involved therein may be combined with each other in case they are not conflict with each other. Further, terms like “comprise”, “include”, and the like are to be construed as including not only the elements described, but also those elements not specifically described, or further comprising elements which are essential to such process, method, article or device. Unless the context clearly requires, throughout the description and the claims, elements defined by recitation with “comprising . . . ” should not be construed as exclusive from the process, method, article or device comprising said elements of other equivalent elements.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

Finally, it should be noted that, the above embodiments are merely provided for describing the technical solutions of the present application, but not intended as a limitation. Although the present application has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present application.

What is claimed is:

1. A method for protecting a CDN server group from DDoS attack, wherein said CDN server group comprises a plurality of CDN servers and a center server, the method comprising:
sending access source information of an access request to the center server by each CDN server;
counting the number of access requests corresponding to the same access source information in each CDN server within a period by the center server;
determining access requests, of which the number is greater than a predetermined threshold, corresponding to the same access source information in each CDN server as DDoS attacks by the center server, and generating a blacklist based on the access source information of the above access requests by the center server;
issuing the blacklist to the plurality of CDN servers in the CDN server group by the center server; and
making the CDN servers refuse to provide a service to an access source in the blacklist.

2. The method of claim 1, wherein the access source information comprises IP information, URL information and/or Refer information.

3. The method of claim 1, wherein the CDN server group is a plurality of CDN server groups arranged on a CDN platform and classified based on different network types.

4. The method of claim 3, wherein after a center server in any one of the plurality of CDN server groups issues the blacklist to a plurality of CDN servers in said one server group, the center server selectively shares the blacklist with center servers in other CDN server groups.

5. A system for protection from DDoS attack for a CDN server group comprising a plurality of CDN servers and a center server, wherein
each CDN server having at least one processor, a memory in electronic communication with the processor and instructions stored in the memory, comprises:
a collecting unit implemented by the at least one processor and configured to collect access source information of an access request,
a sending unit implemented by the at least one processor and configured to send the access source information to the center server,
a blacklist receiving unit, and
a service controlling unit implemented by the at least one processor and configured to be associated with the blacklist receiving unit, so as to refuse service provision to an access source in a blacklist; and
the center server having at least one processor, a memory in electronic communication with the processor and instructions stored in the memory, comprises:
a counting unit implemented by the at least one processor and configured to count the number of access requests corresponding to the same access source information in each CDN server within a period,
a blacklist generating unit implemented by the at least one processor and configured to determine access requests, of which the number is greater than a predetermined threshold, corresponding to the same access source information in
each CDN server as DDoS attacks, and generate a blacklist based on the access source information of the above access requests, and
an issuing unit implemented by the at least one processor and configured to issue the blacklist to the blacklist receiving units in the plurality of CDN servers in the CDN server group.

6. The system of claim 5, wherein the collecting unit is an nginx module.

7. The system of claim 6, wherein the access source information comprises IP information, URL information and/or Refer information.

8. The system of claim 5, wherein the CDN server group is a plurality of CDN server groups arranged on a CDN platform and classified based on different network types.

9. The system of claim 8, wherein a center server in any one of the plurality of CDN server groups is configured to selectively share a blacklist with center servers in other CDN server groups.

10. An electronic device for protecting a CDN server group from DDoS attack, comprising:
at least one processor; and
a memory communicably connected with the at least one processor for storing instructions executable by the at least one processor, wherein execution of the instructions by the at least one processor causes the at least one processor to:
receiving access source information of an access request from each CDN server;
counting the number of access requests corresponding to the same access source information in each CDN server within a period;
determining access requests, of which the number is greater than a predetermined threshold, corresponding to the same access source information in each CDN server as DDoS attacks, and generating a blacklist based on the access source information of the above access requests;
issuing the blacklist to the plurality of CDN servers in the CDN server group; and
making the CDN servers refuse to provide a service to an access source in the blacklist.

11. The electronic device of claim 10, wherein the access source information comprises IP information, URL information and/or Refer information.

12. The electronic device of claim 10, wherein the CDN server group is a plurality of CDN server groups arranged on a CDN platform and classified based on different network types.

13. The electronic device of claim 12, wherein execution of the instructions by the at least one processor further causes the at least one processor to selectively share the blacklist with center servers in other CDN server groups after sending the blacklist to a plurality of CDN servers in one server group.
